(19) United States
(12) Patent Application Publication
(10) Pub. No.: US 2003/0046147 A1
(43) Pub. Date: Mar. 6, 2003

(54) Method and system for selling a plurality of items

(76) Inventor: Matthew Bondy, Waterloo (CA)

Correspondence Address: PEARNE & GORDON LLP, 526 SUPERIOR AVENUE EAST, SUITE 1200, CLEVELAND, OH, 44114-1484, US

(21) Appl. No.: 09/822,160

(22) Filed: Mar. 30, 2001

Related U.S. Application Data
(60) Provisional application No. 60/193,394, filed on Mar. 31, 2000.

(51) Int. Cl. G06F 17/60

(52) U.S. Cl. 705/14

(57) ABSTRACT

A method and system for selling a plurality of items through an electronic retailer is disclosed. The method includes steps of enrolling a group as a group membership or partnership entity, providing the group with various Internet-related services, and embedding in the group Web site a hyperlink to an electronic retailing system including an electronic store, so that members of the group can visit directly the electronic retailer and electronically order products or services, while enjoying the Internet services provided by the electronic retailer. A computer system for conducting these business activities is also disclosed, which generally includes an Internet service providing system for providing Internet-related services to the groups, an electronic retailing system for electronically selling products and services to the potential purchasers, and a database for storing information and data relating to the above business processes.

### CROSS REFERENCE TO RELATED APPLICATIONS

This application claims priority from a provisional application Serial No. 60/193,394 filed Mar. 31, 2000. That provisional application is incorporated herein by reference for all purposes

### FIELD OF THE INVENTION

The present invention generally relates to an electronic business method and system, and more particularly a method and system for attracting the attention of a group of potential purchasers having a common interest in a certain activity and for promoting and selling products and services.

### BACKGROUND OF THE INVENTION

Industry research has shown that one of the most exciting applications of Internet technology is Internet-based electronic retailing (e-tailing). This US $25.8 billion industry, as reported by the US government for 2000, is projected to soar to $269 billion by 2005.

However, the elimination of a physical retail store does not come without some significant drawbacks. Research has also shown that intangibles such as security and sense of community significantly affect market penetration But there are two more serious issues. First, the cost of shipping individual products directly to each customer can be extremely problematic, especially for relatively inexpensive commodity items, such as books and music CDs. Second, the advertising necessary to attract consumers to a Web site is expensive. That is, e-tailers have paid as much as $19 million dollars to place an advertising button on one of the portal web sites, in hopes of attracting some ‘virtual foot traffic’. To provide a reasonable landed cost in comparison with local stores, the online equivalents have had to deeply discount their offerings and suffer the corresponding gross margin hit. Ironically, the portal sites have been able to obtain a lot of traffic by giving away free content, but have difficulty building a profitable model that is primarily based on advertising revenue.

In summary, current entailing ventures are typically plagued with two common problems: compressed gross margins due to the discounts required to compensate for the high cost of direct-to-consumer shipping and escalated sales and marketing expenses associated with attracting virtual foot traffic.

### SUMMARY OF THE INVENTION

The inventor has recognized these problems and has developed a new model of e-tailing, including aspects of the traffic generating concept of the portal model (which may include free content) with the high sales of the e-commerce model.

In accordance with the present invention, there is provided a method of selling items comprising the steps of: (a) providing an e-tailing system for displaying information relating to items available for purchase, and for receiving and processing orders to purchase such items; (b) providing a hyperlink from a web site to the e-tailing system; (c) at the entailing system, receiving a plurality of orders to purchase items, the plurality of orders being initiated by a plurality of purchasers associated with the web site and using the hyperlink to access the e-tailing system from the web site; (d) processing the plurality of orders at the e-tailing system and identifying a corresponding plurality of items purchased; and (e) shipping the plurality of items purchased to a geographical location associated with the plurality of purchasers.

Embodiments of the invention include a method and system for selling a plurality of items through an electronic retailer including the steps of enrolling a group as a group membership or partnership entity, providing the group with various Internet-related services, and embedding in the group Web site a hyperlink to an electronic retailing system including an electronic store, so that members of the group can visit directly the electronic retailer and electronically order products or services, while enjoying the Internet services provided by the electronic retailer. Embodiments of the invention also include a computer system for conducting these business activities, which generally includes an Internet service providing system for providing Internet-related services to the groups, an electronic retailing system for electronically selling products and services to the potential purchasers, and a database for storing information and data relating to the above business processes.

Embodiments of the invention include aspects of the traffic generating concept of the portal model with aspects of the high sales e-commerce model. Furthermore, an onsite retailing system can be implemented in the physical group building or facilities, so that members who are not on the Internet at home, can still enroll and purchase using an Internet-connected computer, for example, kiosk installed in the group building or facilities.

A further understanding of the other features, aspects, and advantages of the present invention will be realized by reference to the following description, appended claims, and accompanying drawings.

### BRIEF DESCRIPTION OF THE DRAWINGS

Embodiments of the invention will now be described with reference to the accompanying drawings, in which:

FIG. 1 is a schematic representation of a business system for conducting business activities in accordance with the present invention;

FIG. 2 shows a home page of an e-tailer in a preferred embodiment in accordance with the present invention;

FIG. 3 shows a sign-up page for an affinity group in a preferred embodiment in accordance with the present invention;

FIG. 4 shows a Web creating page to be used by an affinity group in a preferred embodiment in accordance with the present invention;

FIG. 5 shows a sample home page of an affinity group in a preferred embodiment in accordance with the present invention;

FIG. 6 shows a sample Web editing page to be used by an affinity group in a preferred embodiment in accordance with the present invention;

FIG. 7 shows a product catalogue Web page of an e-tailer in a preferred embodiment in accordance with the present invention;

FIG. 8 shows a product catalogue Web page of an affinity group in a preferred embodiment in accordance with the present invention; and

FIG. 9 shows a schematic diagram illustrating order processing and shipping in accordance with the present invention.

### DETAILED DESCRIPTION OF THE PREFERRED EMBODIMENT(S)

Embodiments of the present invention include providing an Internet service to a group of potential purchasers, and/or embedding in their Web sites an electronic store hyperlinked to an electronic retailing system, so that the group members can navigate directly and readily the electronic store and electronically purchase products and services, thereby promoting the sale of products and services. For convenience of explanation of the invention, the group of potential purchasers, which has a common interest in a certain activity, for example, a church, a school, or a health club, is hereinafter referred to as an “affinity group” or an “affinity organization.” The individual potential purchaser will be referred to as a “group member.”

Embodiments of the invention include a method of attracting attention of the affinity groups and promoting sales of products and services of an electronic retailer (hereinafter, referred to as an e-tailer) and a system for conducting these business activities.

Generally, embodiments of the invention include several steps of activities, i.e., preparing an electronic retailing system (hereinafter, referred to as an “e-tailing system”) for selling products and services, preparing an Internet service providing system for providing Internet services to a plurality of affinity groups or organizations, enrolling the groups or organizations as group membership or partnership entities, providing the affinity groups with the Internet service, embedding in the Web sites of the groups a hyperlink to the e-tailing system to which the group members can navigate directly and electronically order the products and services, and processing the electronic orders. The Internet service for the affinity groups may include a variety of services, for example, assisting the affinity groups in establishing their own Web sites, providing the affinity group with a Web hosting service, or providing an Internet domain name service, etc. The hyperlink to the e-tailing system may be implemented as an electronic store menu or icon posted on the Web page of the affinity group Wet site. More specifics and details on the present method will be described hereafter, referring to the business system of the invention and an exemplary embodiment therefor.

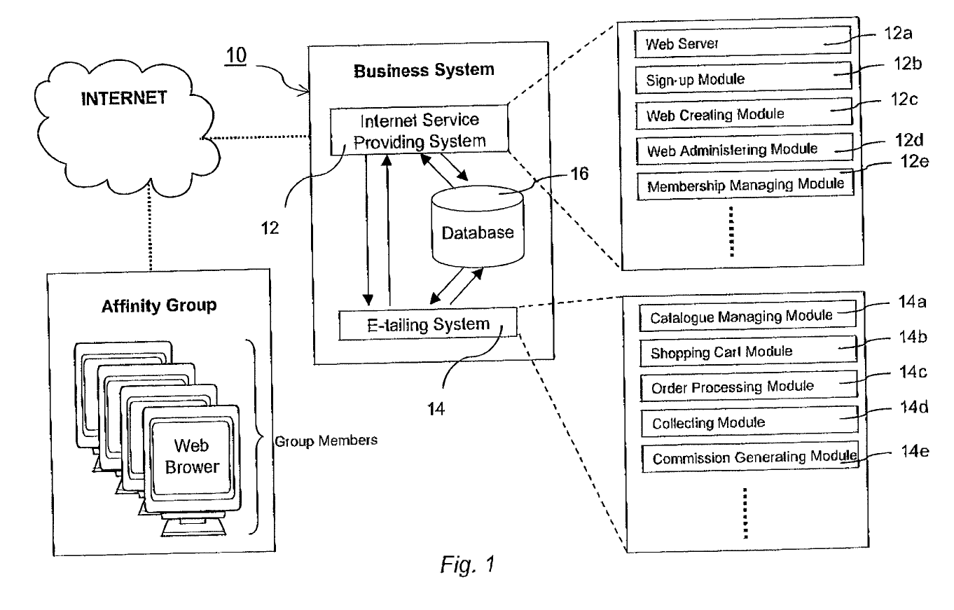

In FIG. 1, there is illustrated a system of the invention which is generally denoted by a reference numeral 10. As depicted in FIG. 1, the system 10 for conducting the foregoing business activities, in general, comprises an Internet service providing system 12 for providing various Internet-related services, an e-tailing system 14 for selling products and services of the e-tailer, and a multipurpose database 16 for storing information and data associated with the business activities. It should be noted that the system of FIG. 1 is a preferred embodiment and, therefore, various other systems and their variants may embody the principles of the present invention. As depicted in FIG. 1, the Internet service providing system 12 may include various subsystems or modules for providing the affinity group with a unique Internet service, for example, a Web server 12a, a sign-up module 12b for enrolling the affinity groups as a membership or partnership entity, a Web site creating module 12c for assisting in establishing a Web site of the enrolled affinity group, a Web site administering module 12d for updating and maintaining the established Web site, a membership managing module 12e, and the like, which will be described hereinafter in greater detail, in conjunction with an exemplary embodiment of the present invention. Also, the e-tailing system 14 may include several subsystems or modules, for example, a catalogue Web page managing module 14a, a shopping cart managing module 14b, an order processing module 14c, a collecting module 14d, and a commission generating module 14e, and the like. These subsystems or modules can be implemented in various ways without limiting the scope of the present invention. For example, the shopping cart module 14b and the order processing module 14c may be combined into a shopping cart and order processing module, or the Web creating module 12c may be divided into several sub-modules, or several other modules may be added according to applications of the invention without departing from the principles of the present invention. As understood by those skilled in the art, the systems and subsystem or sub-modules shown in FIG. 1 will be co-operating in order to conduct the electronic business activities according to the present invention.

A preferred embodiment will be described below. Various significant features and advantages associated with them will be also described. In this embodiment, the e-tailer will be represented by “Intrinity Incorporated,” which is a licensee of the present invention and hereinafter referred to as “Intrinity,” and the affinity group or affinity organization will be represented by a church named by “Koinonia Christian Fellowship,” which will be referred to as “Koinonia” hereinafter.

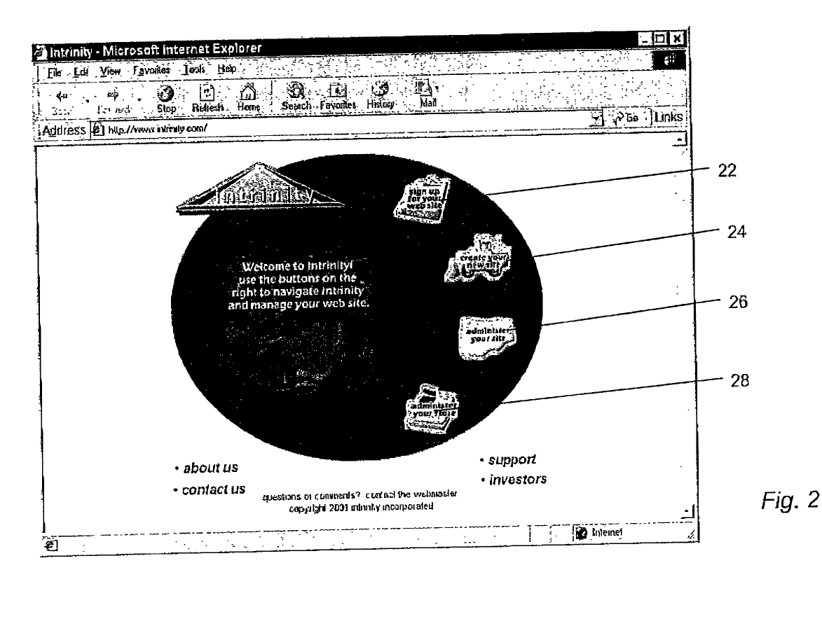

FIG. 2 shows a screen shot of the home page of Intrinity which conducts the business activities. The home page of FIG. 2 includes several icons, i.e., a sign-up icon 22, a new Web site creating icon 24, a Web site administering icon 26, a store-administering icon 28, and other information about Intrinity itself or its business activities. A user, i.e., an administrator of the church Koinonia noted above (hereinafter, “site administrator”), can visit the Web page of FIG. 2 (www.intrinity.com) and begin the sign-up process. That is, the administrator clicks on the sign-up icon 22 and, then, the Web server 12a of the Internet service providing system in FIG. 1 retrieves a sign-up page and sends it to the administrator.

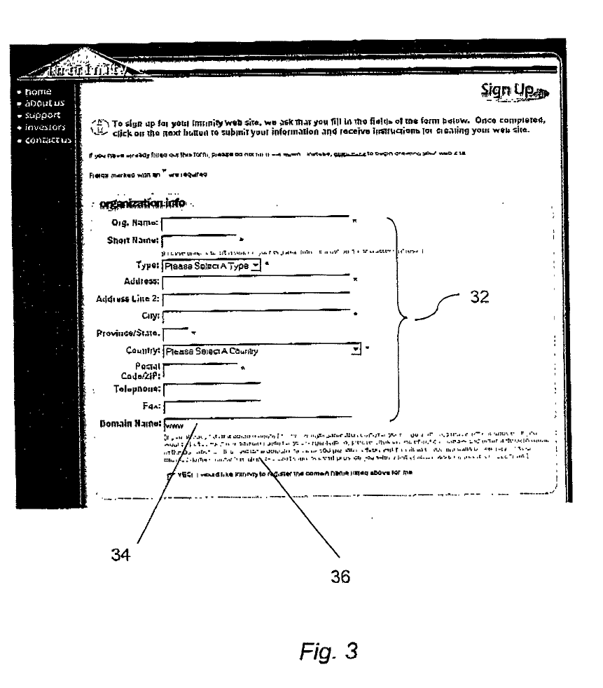

In FIG. 3, there is shown a sign-up page designed for this embodiment, which includes various usual information fields 32, which are required to be filled out by the site administrator, including affinity group demographics and desired user ID, and the like. When a domain name service is required, the site administrator may fill in a domain name field 34 with any desired name, as directed by a related description 36 in the sign-up page of FIG. 2. Then, the information entered by the site administrator is sent back to system 10 of FIG. 1 in which the sign-up module 12b is activated and processes the application. The sign-up module 12b also determines whether the information sent by the site administrator is complete and valid. If the information provided by the site administrator is either incomplete or invalid, the sign-up module 12b generates appropriate error messages on the sign-up page, which is sent by the Web server 12a back to the site administrator so that corrections can be made and resent to the system. While this embodiment involves only an online sign-up process, in accordance with the concept of the invention, a paper version sign-up process may be carried out between the site administrator and the system administrator, for example, by mail or fax. If the information is complete and valid, system 10 of FIG. 1 instructs the Web server 12a to send a confirmation page or message to the site administrator's web-browser, which may provide instructions on gathering information necessary for establishing a Web site of Koinonia. It will be understood by those skilled in the art that various security processes may also be carried out during or after the sign-up process. The information or data related to every process will be stored in the database 16 of system in FIG. 1 during the whole business activity in this embodiment.

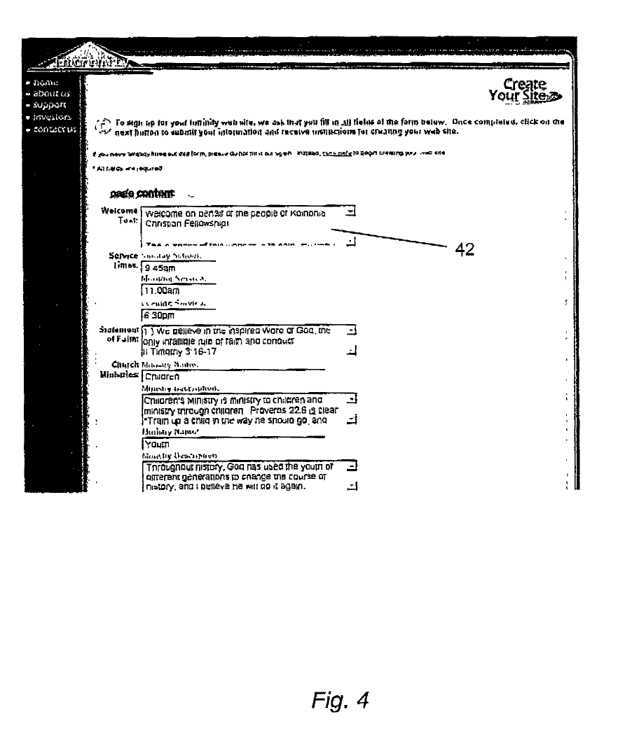

Subsequently, with the information necessary for creating a basic Web site for the affinity organization, Koinonia, the site administrator visits the home page of Intrinity again, and clicks on the new Web site creating icon 24 in FIG. 2. Then, the Web server 12a of system retrieves and sends a Web creating page to the site administrator. System 10 of the invention contains various Web site frameworks, each of which may serve as a basic architecture in creating a Web site of a certain affinity group, for example, a church, a school, or a health club. In this embodiment, therefore, the Web server 12a can send an appropriate Web site framework for a church, as shown in FIG. 4. The Web site framework of FIG. 4 provides various fields necessary for creating a basic Web site for a church, for example a welcome text field 42.

The Web site framework may be designed to automatically include a hyperlink to the e-tailing system as an electronic store menu or icon in the Web site, preferably, in every Web page of the affinity group Web site. The Web site framework may be configured to guide and help the affinity groups to create their Web sites. More details an this feature will be explained below.

Referring back to the Web framework in FIG. 4, the information inputted by the site administrator is sent back to system 10 of FIG. 1, where it is received by the Web server 12a and processed by the Web creating module 12c of the Internet service providing system 12 in FIG. 1. Let it be assumed that the field of welcome text 42 has been filled out as following: “Welcome on behalf of the people of Koinonia Christian Fellowship!” The Web creating module 12c generates a Web page for the church by utilizing the above information filled in by the site administrator and stores it in an appropriate Web storage space of the database 16.

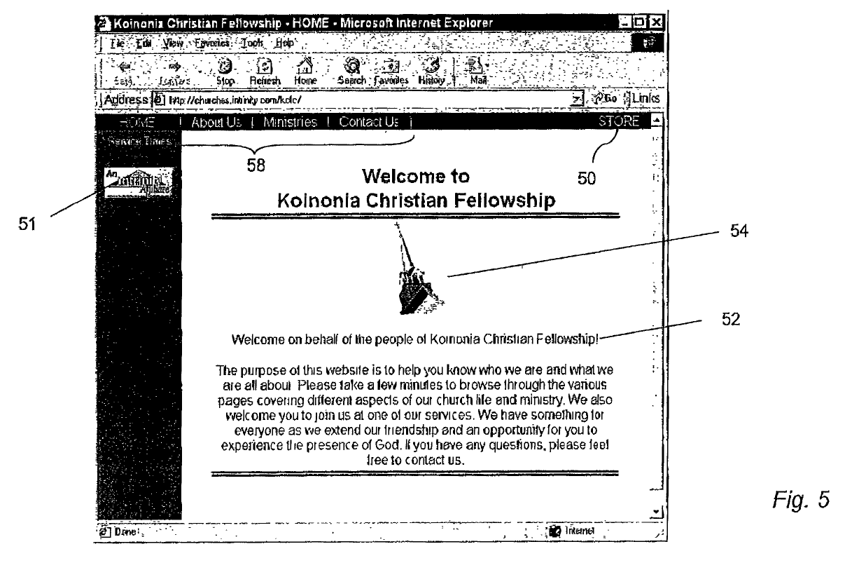

FIG. 5 is presenting the Web page of the church, Koinonia, which is generated by the Web creating module 12c and sent back to the site administrator. As shown in FIG. 5, the home page of Koinonia includes a welcome statement 52, which is filled out by the site administrator at the previous step. Also, the Web page has a photo 54 showing a church building and a menu bar 58 leading to various Web pages of the church. Most importantly, the home page of FIG. 5 includes a hyperlink to the e-tailing system 14 as an electronic store 50 (hereinafter, “e-store”) and information or an advertisement 51 in accordance with one of the significant features of the present invention. Other Web pages of the church, Koinonia, may include the e-store 50 and the advertising statement 51. Therefore, all the members of the church, Koinonia, can visit their Web site and purchase products and services offered by the e-tailer, Intrinity, at any time while enjoying navigating the online presence. Also, the members who are not on the Internet at home can visit their Web site at the church and electronically purchase products and services by using an Internet-connected computer installed in their church building or facilities.

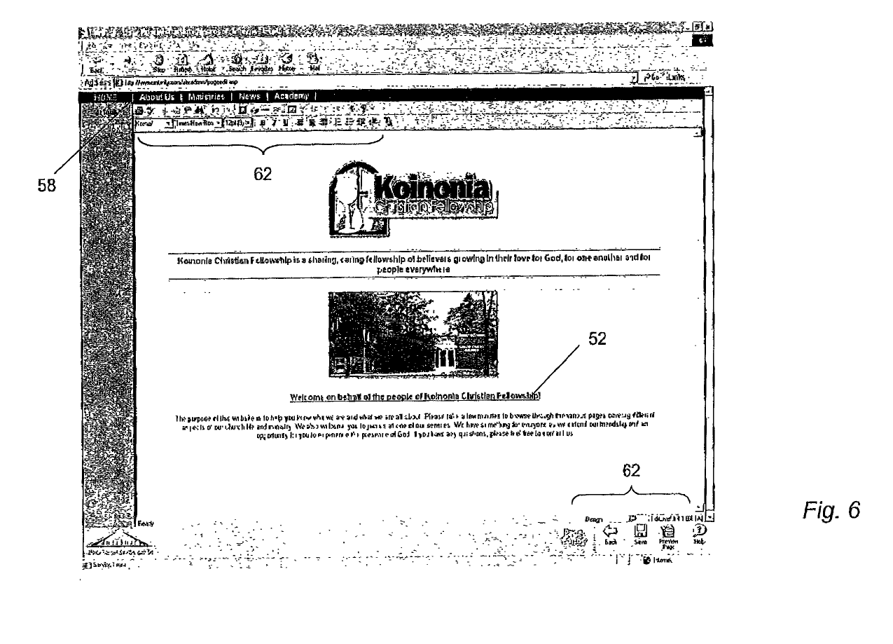

Whenever the home page of FIG. 5 is required to be updated, corrected or modified, the site administrator can visit the home page of Intrinity shown in FIG. 2 and click on the Web site administering icon 26, in response to which the Web server 12a of the system 12 retrieves a Web page editor and sends it to the site administrator. FIG. 6 shows one example of the Web page editor, in which all elements of the home page of the church, Koinonia, can be easily and simply modified or corrected by using edit menus 62. The details on the Web page editing will be understood to those skilled in the art. In this way, the site administrator can modify or correct every item and attribute (e.g., font, color, size, etc.) of all the existing Web pages of his or her organization, except for the electronic store 50 and the advertising statement 51 of the e-tailer, Intrinity Incorporated, in this embodiment. However, the affinity groups may offer and sell their own materials, for example, in this embodiment, sermon tapes, books, videos, etc. Further details on this feature and its associated advantages will be described below.

Each affinity organization can add its own products or services to the e-store of the e-tailer as part of a partnership. Therefore, in this embodiment, the site administrator can visit the home page of Intrinity shown in FIG. 2 and click on the store administering icon 28, in response to which the Web server 12a retrieves a store editing page and sends it to the site administrator. By using the store editing page, the site administrator may define a custom church store, where they can offer their own materials, such as a sermon tape, a book, and the like. Also, the site administrator can modify or remove the existing items from the custom church store. Details on the creating and editing of the e-store will be understood by those skilled in the art of web-page design, and therefore be omitted in the description for clear understanding of the principles to the business activities in accordance with the present invention.

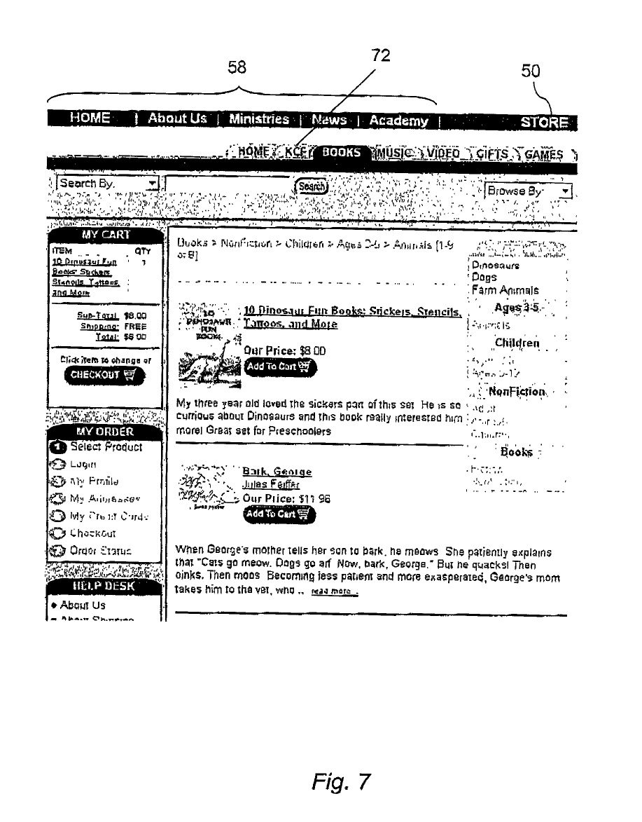

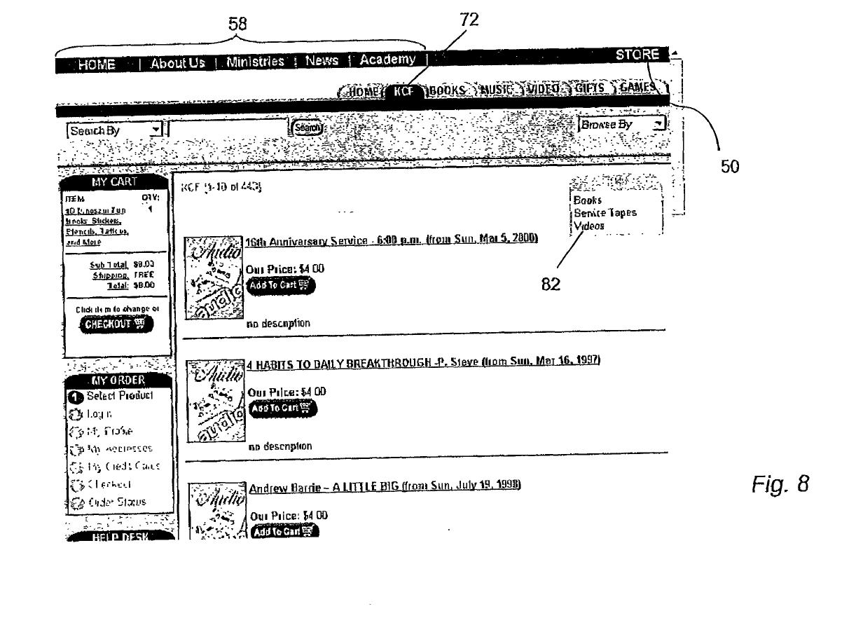

With reference to the Web site of Koinonia shown in FIG. 5, every individual of the congregation of the church can enjoy the Internet services, which are provided by Intrinity in accordance with the present invention. Also, they can purchase products and services electronically through the e-store 50 of FIG. 5. As noted above, the products and services may be offered by the e-tailer, Intrinity, and/or the church, Koinonia. That is, whenever they want to buy or search for items they need, they only have to click on the e-store menu 50 and visit the electronic store of Intrinity, which is shown in FIG. 7. As will be understood to those skilled in the art, the electronic store of FIG. 7 appears similar to various usual electronic stores, except for a menu 72 named as “KCF.” As noted above, this menu 72 is hyperlinked to a customized affinity group store, in this embodiment, the e-store of the church, Koinonia. When the group members want to search the church store or buy a product from their church, they can click on the menu 72 and visit the church store shown in FIG. 8. FIG. 8 shows a customised church Web store, which includes a classified product menu 82, and the like, as can be seen in usual electronic stores.

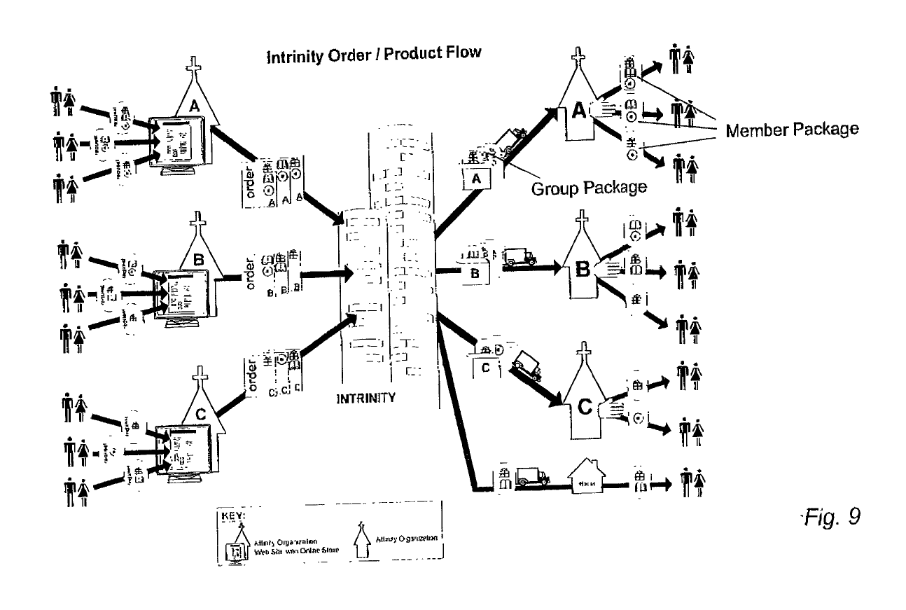

Referring to FIG. 9, order processing and shipping and advantages associated with them will be explained below. As shown in FIG. 9, each electronic order will be processed individually according to the purchasers, i.e., packed into an individual package (hereinafter, referred to as a “member package”). All the individual packages are classified according to the affinity organizations or groups to which the respective order belongs, and packed again into a big package (hereinafter, referred to as a “group package”). Preferably, each group package may contain a bulk packing slip, listing all the member packages included therein, and each member package in the group package also contains an individual packing slip. Subsequently, each group package is delivered to the respective affinity organization, as depicted in FIG. 9. When the respective affinity group receives the group packages, the organization may keep the bulk packing slip for their records. Finally, each purchaser can pick up his or her ordered package from the organization to which he or she belongs, for example, when he or she visits the church, Koinonia, in this embodiment. Alternatively, the member package may be delivered directly to the corresponding purchaser with an additional shipping charge according to his or her special order. Preferably, the order processing noted above may be performed weekly or monthly, for example, according to a contract between the e-tailer and the respective affinity group.

The e-tailer, Intrinity, may collect all payment directly from every individual purchaser, or the affinity organization, Koinonia, may collect the payments from their group members on behalf of Intrinity.

As describe above, the electronic orders may be processed in a predetermined interval or period and/or in a batch style according to the present invention, so that processing or service cost can be considerably reduced. Therefore, the reduced cost may be reflected in the prices of the products or services, or shared with the respective affinity group as part of a partnership practice. In this embodiment, for example, the church, Koinonia, may receive a commission cheque from Intrinity on a regular basis, depending, for example, upon the number of orders by the group members.

As will be understood by those skilled in the art, the present invention provides a new model of electronic retailing, which cooperatively combines aspects of the traffic generating concept of the portal model (which may include free content) with aspects of the high sales e-commerce model. As described above, all the members of the affinity organization or group can visit their Web site and, electronically purchase products and services offered by the e-tailer at home or at their organization's geographical location at any time while enjoying navigating the online presence. Furthermore, an offline retailing system can also be implemented in the physical group building or facilities, for example, the church building, so that members who are not on the Internet at home, can still enroll and purchase using an Internet-connected computer, for example, kiosk installed in the group building or facilities.

Numerous modifications, variations and adaptations may be made to the particular embodiments of the invention described above without departing from the scope of the invention, which is defined in the claims.

What is claimed is:

1. A method of selling items comprising the steps of:
(a) providing an e-tailing system for displaying information relating to items available for purchase, and for receiving and processing orders to purchase such items;
(b) providing a hyperlink from a web site to the e-tailing system;
(c) at the e-tailing system, receiving a plurality of orders to purchase items, the plurality of orders being initiated by a plurality of purchasers associated with the web site and using the hyperlink to access the e-tailing system from the web site;
(d) processing the plurality of orders at the e-tailing system and identifying a corresponding plurality of items purchased; and
(e) shipping the plurality of items purchased to a geographical location associated with the plurality of purchasers.

2. A method of promoting and selling the products and services of an e-tailer, the method comprising steps of:
(a) providing an electronic retailing architecture;
(b) providing a Web site;
(c) providing a group associated with said Web site, said group comprising a plurality of people;
(d) providing a hyperlink between said Web site and said electronic retailing architecture for ordering goods;
(e) a geographical location for receiving said goods.

3. A method according to claim 2, further comprising a step of delivering said goods, the delivering step comprising steps of:
(i) packaging said goods into a member package;
(ii) packaging said member package into a group package;
(iii) delivering said group package to said geographical location.

4. A method according to claim 3, wherein said group package is delivered in a predetermined interval or period.

5. A method according to claim 2, further comprising a step of providing an Internet service to said group.

6. A method according to claim 5, wherein said Internet service comprises at least one of followings:
(i) assisting said group in establishing a Web site;
(ii) providing said group with a Web hosting service; and
(iii) providing said group with an Internet domain name service.

7. A method according to claim 6, further comprising a step of preparing and maintaining a plurality of Web site frameworks, each of which serves as a basic architecture in creating said Web site.

8. A method according to claim 7, wherein said Web site framework is designed to include said hyperlink.

9. A method according to claim 7, wherein said Web site framework is configured to guide and help said group to create said Web site.

10. A method according to claim 2, wherein said hyperlink is embedded in said Web site as an electronic store.

11. A method according to claim 10, wherein said electronic store includes an electronic store of said group.

12. A method according to claim 2, wherein said group may be an affinity group.

13. A method according to claim 12, wherein said affinity group may be a church, a school, or a health club.

14. A method according to claim 2, further comprising a step of posting on said Web site an advertisement and information relating to said e-tailer.

15. A method according to claim 2, further comprising a step of enrolling said group as a membership or partnership entity.

16. A business system for promoting and selling the products and services of an e-tailer, the system comprising:
(a) an electronic retailing architecture:
(b) a Web site;
(c) a group associated with said Web site, said group comprising a plurality of people;
(d) a hyperlink between said electronic retailing architecture and said Web site for ordering goods; and
(e) a geographical location associated with said group for receiving said goods.

17.A business system according to claim 16, further comprising an Internet service system for providing an Internet service to said group.

18. A business system according to claim 17, wherein said Internet service comprises at least one of followings:
(i) assisting said group in establishing a Web site;
(ii) providing said group with a Web hosting service; and
(iii) providing said group with an Internet domain name service;

19. A business system according to claim 18, wherein said Internet service system comprises a system for online creating, online updating and online maintaining said Web site.

20. A method according to claim 16, wherein said hyperlink is embedded in said Web site as an electronic store.

21. A method according to claim 20, wherein said electronic store includes an electronic store of said group.

22. A method according to claim 16, wherein said group may be an affinity group.

23. A method according to claim 22, wherein said affinity group may be a church, a school, or a health club.
